(19) United States
(12) Patent Application Publication
(10) Pub. No.: US 2012/0145624 A1
(43) Pub. Date: Jun. 14, 2012

(54) WATER FILTER CARTRIDGE

(76) Inventor: Min-Hua Chang, (US)

(21) Appl. No.: 12/967,038

(22) Filed: Dec. 13, 2010

(51) Int. Cl. B01D 36/02; C02F 1/42; C02F 1/58; C02F 1/28

(52) U.S. Cl. 210/266; 210/295

(57) ABSTRACT

A water filter cartridge includes a hollow cylindrical first filter for removing particulates and other foreign matter from the water and comprising an axial space, an open outlet at one end, and a closing cap at the other end; a second filter for filtering chlorine, odor, color, and organic contaminants from the water and disposed in a lower portion of the space, the second filter being a hollow cylinder and comprising an open bottom, an open top, and an axial space; and a cylindrical filtering block for removing microorganisms from the water and disposed between the outlet and the second filter, the filtering block comprising a waterproof layer on an outer surface and a sponge member filled in a space defined by the waterproof layer.

### BACKGROUND OF THE INVENTION

1. Field of Invention

The invention relates to water filtration and more particularly to a water filter cartridge with improved characteristics.

2. Description of Related Art

It is estimated that over one billion people worldwide lack access to clean drinking water. Water-borne diseases are one of the leading causes of disease and death in the world. Many water systems fail due to complexity of operations, costs, expense, inconvenient use, not portable, and requiring chemicals and energy. Industries are seeking sustainable cost effective water supply systems to provide water to their facilities. In dealing with water scarcity, there is an increasing demand for rain water and industrial wastewater filtration and recycling using sustainable systems that do not rely on additional chemical treatment or extensive maintenance. There are many different approaches to providing clean drinking water such as filtration, ultra filtration, UV (ultra violet) oxidation, and chemical disinfection. These approaches typically address only parts of the needs for water purification. Water treatment units that rely on portable hydrocarbon based power generation increase the risk of contamination of the water source.

There is a commercially available type of water filter including a cylindrical hollow filter cartridge having multiple filter pads, a layer of granulated zinc and copper alloy, a layer of granulated activated carbon, a layer of ion-exchange resin, and a layer of granulated calcite. However, the manufacturing cost and component replacement (i.e., maintenance) cost of the water filter are very high.

Thus, the need for an improved water filter cartridge of a water filter with low cost and low maintenance still exists.

### SUMMARY OF THE INVENTION

It is therefore one object of the invention to provide a water filter cartridge for filtration of raw water into drinking water, comprising a hollow cylindrical first filter for removing particulates and other foreign matter from the water and comprising an axial space, an open outlet at one end, and a closing cap at the other end; a second filter for filtering chlorine, odor, color, and organic contaminants from the water and disposed in a lower portion of the space, the second filter being a hollow cylinder and comprising an open bottom, an open top, and an axial space; and a cylindrical filtering block for removing microorganisms from the water and disposed between the outlet and the second filter, the filtering block comprising a waterproof layer on an outer surface and a sponge member filled in a space defined by the waterproof layer.

The above and other objects, features and advantages of the invention will become apparent from the following detailed description taken with the accompanying drawings.

### BRIEF DESCRIPTION OF THE DRAWINGS

FIG. 1 is a perspective view of a filter cartridge according to a first preferred embodiment of the invention;

FIG. 2 is an exploded view of the filter cartridge;

FIG. 3 is a longitudinal sectional view of the filter cartridge mounted in a water filter housing which is connected to a water supply so that raw water flowing from the water supply can be purified by the filter cartridge;

FIG. 4 is a perspective view of a filter cartridge according to a second preferred embodiment of the invention;

FIG. 5 is a longitudinal sectional view of the filter cartridge of FIG. 4 with water flow being indicated;

FIG. 6 is a longitudinal sectional view showing another configuration of the filter cartridge of FIG. 3 mounted in a water filter housing;

FIG. 7 is a longitudinal sectional view showing another configuration of the filter cartridge of FIG. 5;

FIG. 8 is a longitudinal sectional view showing still another configuration of the filter cartridge of FIG. 3 mounted in a water filter housing; and

FIG. 9 is a longitudinal sectional view showing still another configuration of the filter cartridge of FIG. 5.

### DETAILED DESCRIPTION OF THE INVENTION

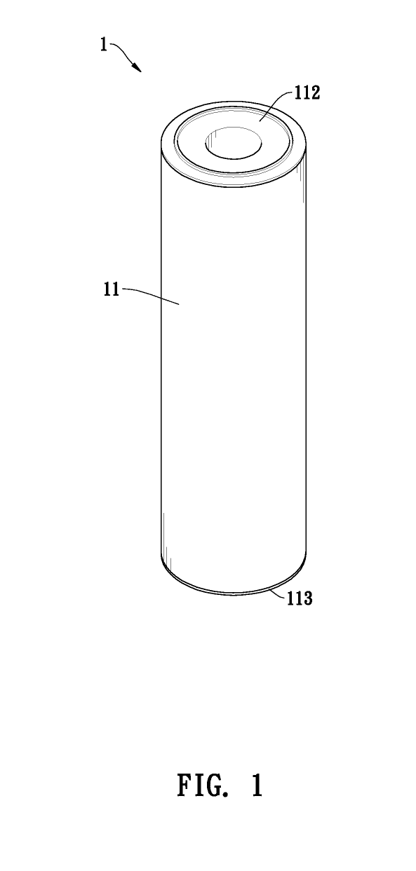

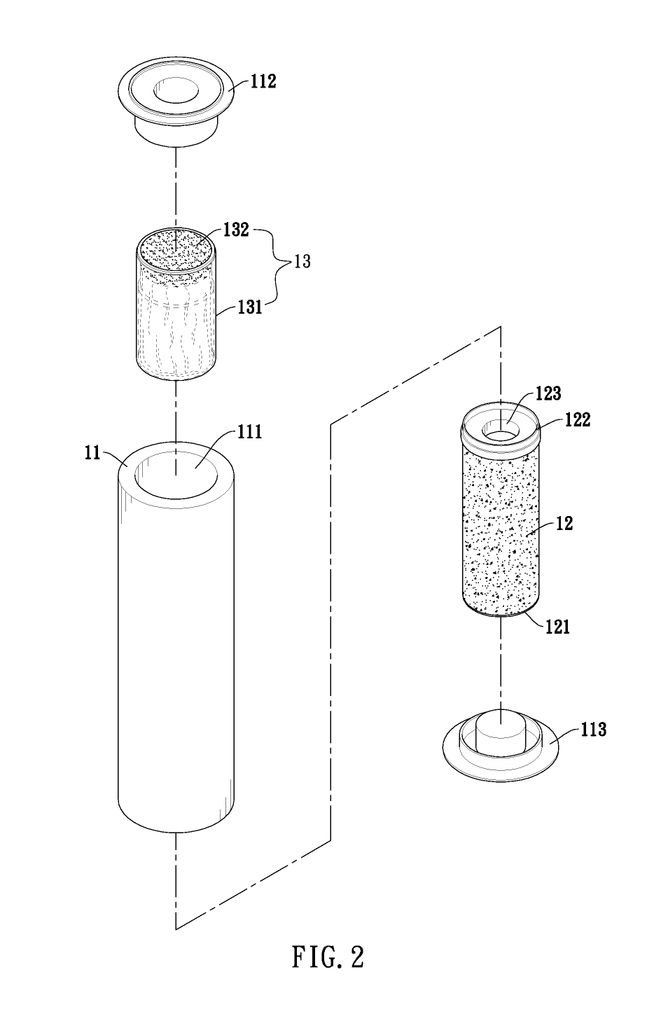

Referring to FIGS. 1 to 3, a water filter incorporating a filter cartridge 1 in accordance with a first preferred embodiment of the invention is shown. The filter cartridge 1 comprises the following components as discussed in detail below.

A first filter 11 is a hollow cylinder 11 having both ends open. The first filter 11 comprises an axial space 111, a top outlet 112, and a bottom closing cap 113. The first filter 11 is made of polypropylene (PP) and used for removing particulates and other foreign matter from the water.

A second filter 12 is disposed in a lower portion of the space 111. The second filter 12 is a hollow cylinder. The second filter 12 comprises an open bottom 121, an open top 122, and an axial space 123. The second filter 12 is made of granulated activated carbon and used for filtering chlorine, odor, color, and organic contaminants from the water.

A filtering block 13 is a cylinder and mounted between the outlet 112 and the second filter 12. The filtering block 13 comprises a waterproof layer 131 on an outer surface and a sponge member 132 filled in a space defined by the waterproof layer 131. The sponge member 132 has a plurality of holes (e.g., 0.1 micron diameter). The waterproof layer 131 prevents water from flowing laterally. That is, water is only allowed to flow from a direction of bottom to top. The filtering block 13 is used for removing microorganisms from the water.

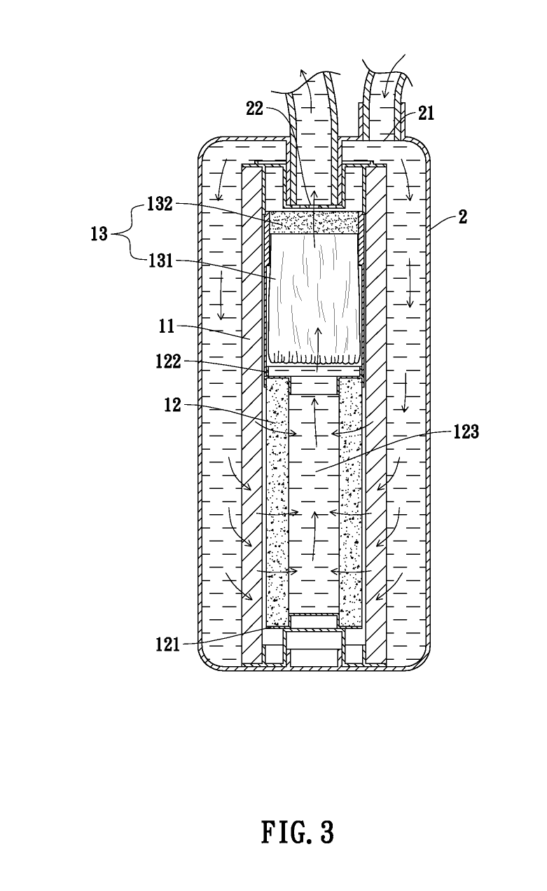

The filter cartridge 1 is disposed in a water filter housing 2 having a water inlet 21 connected to a water supply source (e.g., municipal water supply tap), and a water outlet 22 connected to the outlet 112. Water flow path into, through, and out of the water filter housing 2 and the filter cartridge 1 is indicated by arrows in FIG. 3. First, the first filter 11 may remove particulates and other foreign matter including sand, rust, and impurities from the water. Next, the second filter 12 may filter chlorine, odor, color, and organic contaminants from the water. Next, the water may flow upward from the space 123 through the sponge member 132 and the outlet 112 prior to leaving out of the water outlet 22 in the form of treated water (i.e., filtrate). The treated water is drinkable for people consumption.

The advantages of the filter cartridge 1 are compact, reduced components, and quality treated water.

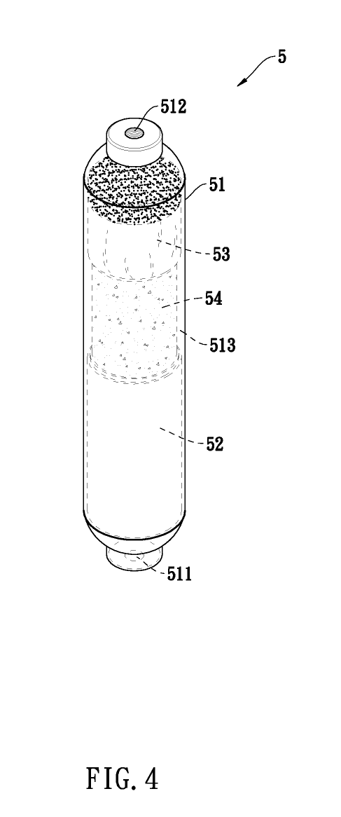

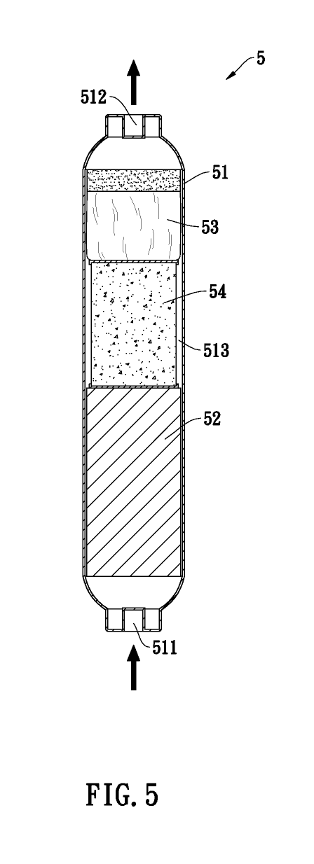

Referring to FIGS. 4 and 5, a filter cartridge 5 in accordance with a second preferred embodiment of the invention is shown. The characteristics of the second preferred embodiment are substantially the same as that of the first preferred embodiment except the following:

A chamber 51 is a hollow cylinder having both projecting ends open. Also, portions adjacent to the ends are truncated conic. The chamber 51 comprises an axial space 513, a top outlet 512, and a bottom inlet 511.

A first filtering block 52 is disposed in a lower portion of the space 513 and is a cylinder. The first filtering block 52 is made of PP and used for removing particulates and other foreign matter from the water.

A second filtering block 53 is a cylinder and disposed in an upper portion of the space 513. The second filtering block 53 is a sponge including a plurality of holes. The second filtering block 53 is used for removing microorganisms from the water.

A filter 54 is disposed between the first filtering block 52 and the second filtering block 53. The first filter 54 is made of granulated activated carbon and used for filtering chlorine, odor, color, and organic contaminants from the water.

In a water treatment process, water flows into the inlet 511 and through the second filtering block 52, the filter 54, and the second filtering block 53 with substantially all contaminants in the water being removed. The treated water finally leaves out of the outlet 512. The treated water is drinkable for people consumption.

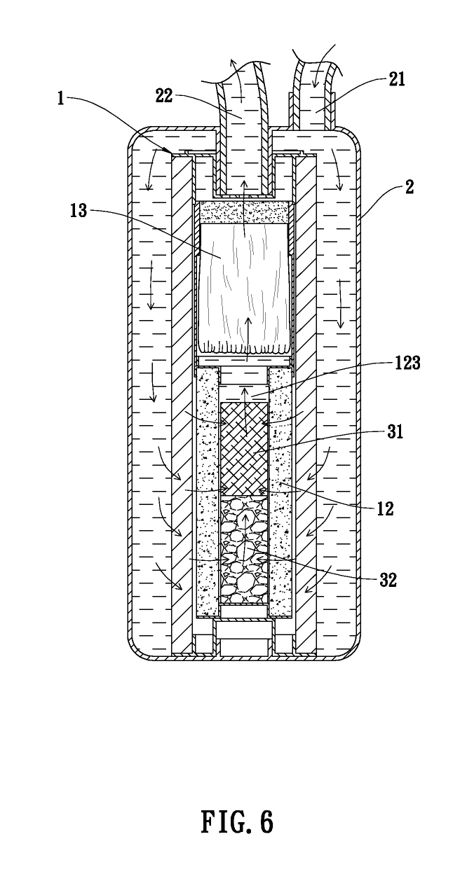

Referring to FIG. 6, in another configuration of the filter cartridge 1 the space 123 may be filled with a lower block of sodium hexametaphosphate (SHMP) 32 for filtering sediments from the water and an upper block of aluminum 31 for filtering lead from the water.

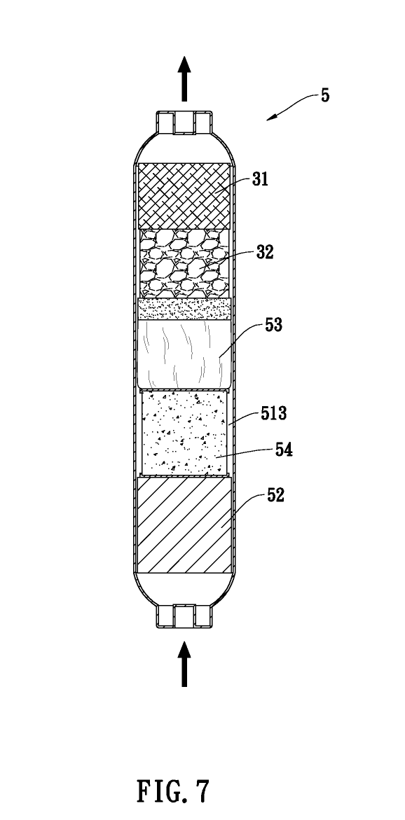

Referring to FIG. 7, in another configuration of the filter cartridge 5 the space 513 may be filled with, from bottom to top, a third filtering block 52, a filter 54, a second filtering block 53, a block of SHMP, and a block of aluminum 31.

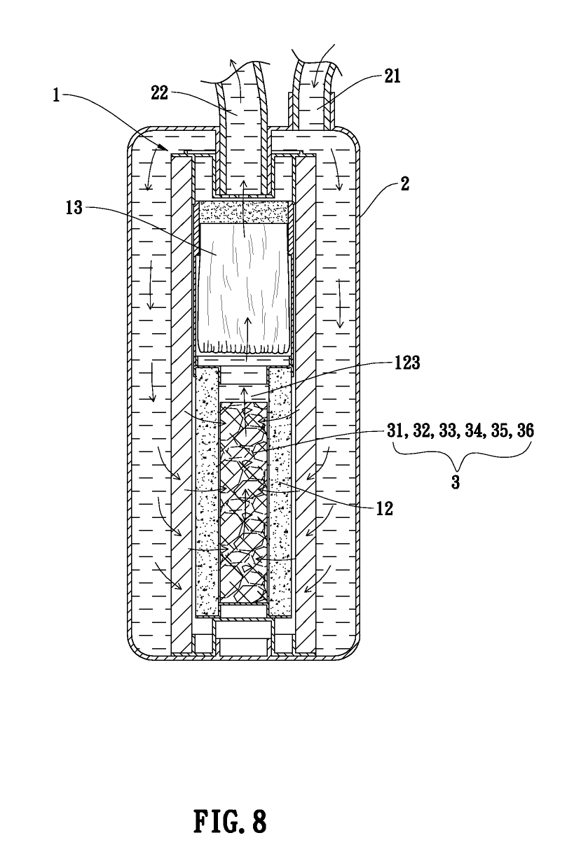

Referring to FIG. 8, in still another configuration of the filter cartridge 1 the space 123 may be filled with a filtering assembly 3 including a block of aluminum 31, a block of SHMP 32, a layer of ion-exchange resin 33, a layer of activated alumina fluorine removing agent 34, a layer of metal removing agent 35, and a layer of ion-exchange polymer 36.

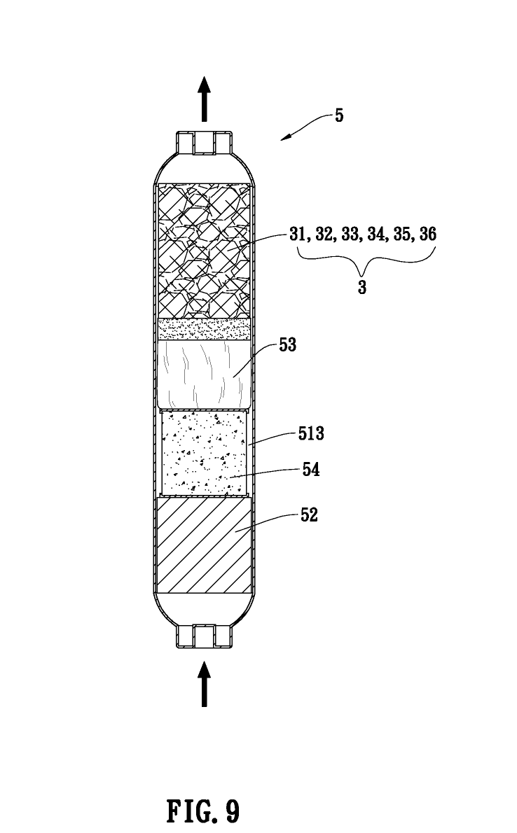

Referring to FIG. 9, in still another configuration of the filter cartridge 5 the space 513 may be filled with, from bottom to top, a third filtering block 52, a filter 54, a second filtering block 53, and a filtering assembly 3 including a block of aluminum 31, a block of SHMP 32, a layer of ion-exchange resin 33, a layer of activated alumina fluorine removing agent 34, a layer of metal removing agent 35, and a layer of ion-exchange polymer 36.

While the invention has been described in terms of preferred embodiments, those skilled in the art will recognize that the invention can be practiced with modifications within the spirit and scope of the appended claims.

What is claimed is:

1. A water filter cartridge for filtration of raw water into drinking water, comprising:
a hollow cylindrical first filter for removing particulates and other foreign matter from the water and comprising an axial space, an open outlet at one end, and a closing cap at the other end;
a second filter for filtering chlorine, odor, color, and organic contaminants from the water and disposed in a lower portion of the space, the second filter being a hollow cylinder and comprising an open bottom, an open top, and an axial space; and
a cylindrical filtering block for removing microorganisms from the water and disposed between the outlet and the second filter, the filtering block comprising a waterproof layer on an outer surface and a sponge member filled in a space defined by the waterproof layer.

2. The water filter cartridge of claim 1, wherein the first filter is formed of polypropylene (PP).

3. The water filter cartridge of claim 1, wherein the second filter is formed of granulated activated carbon.

4. The water filter cartridge of claim 1, wherein the sponge member comprises a plurality of holes.

5. The water filter cartridge of claim 1, wherein the space is filled with a block of aluminum for filtering lead from the water, a block of sodium hexametaphosphate (SHMP) for filtering sediments from the water, a layer of ion-exchange resin, a layer of activated alumina fluorine removing agent, a layer of metal removing agent, and a layer of ion-exchange polymer.

6. A water filter cartridge for filtration of raw water into drinking water, comprising:
a hollow cylindrical chamber comprising a bottom inlet, a top outlet, and an axial space;
a first filtering block for removing particulates and other foreign matter from the water and disposed in a lower portion of the space;
a second filtering block for removing microorganisms from the water and disposed in an upper portion of the space; and
a filter or filtering chlorine, odor, color, and organic contaminants from the water and disposed between the first filtering block and the second filtering block.

7. The water filter cartridge of claim 6, wherein the first filtering block is formed of polypropylene (PP).

8. The water filter cartridge of claim 6, wherein the second filtering block is a sponge including a plurality of holes.

9. The water filter cartridge of claim 6, wherein the first filter is formed of granulated activated carbon.

10. The water filter cartridge of claim 6, wherein the space is filled with a filtering assembly including a block of aluminum for filtering lead from the water, a block of sodium hexametaphosphate (SHMP) for filtering sediments from the water, a layer of ion-exchange resin, a layer of activated alumina fluorine removing agent a layer of metal removing agent, and a layer of ion-exchange polymer.
